(19) United States
(12) Patent Application Publication
(10) Pub. No.: US 2016/0349671 A1
(43) Pub. Date: Dec. 1, 2016

(54) ELECTROPHOTOGRAPHIC BELT AND ELECTROPHOTOGRAPHIC APPARATUS

(71) Applicant: CANON KABUSHIKI KAISHA, Tokyo (JP)

(72) Inventor: Noriaki Egawa, Komae-shi (JP)

(21) Appl. No.: 15/162,442

(22) Filed: May 23, 2016

(30) Foreign Application Priority Data
May 27, 2015 (JP) 2015-107876

(51) Int. Cl. B32B 9/04; G03G 15/01

(52) U.S. Cl. CPC G03G 15/162

(57) ABSTRACT

Provided is an electrophotographic belt capable of preventing a bleed-out of a dispersant or an ion-conductive agent, wherein the electrophotographic belt includes a base layer and a surface layer, wherein the surface layer contains a matrix containing resin, conductive particles dispersed in the matrix, and a dispersant, and the matrix further contains a silicon oxide in a non-phase-separated state together with the resin, and wherein the silicon oxide is one derived from polysilazane.

### BACKGROUND

Field of the Disclosure

The present disclosure relates to an electrophotographic belt usable as a conveying transfer belt or an intermediate transfer belt for use in an electrophotographic image-forming apparatus (hereinafter referred to as “electrophotographic apparatus”).

Description of the Related Art

A known electrophotographic belt used as a conveying transfer belt or an intermediate transfer belt has a configuration in which a surface layer containing an acrylic resin is placed on a base layer containing a conductive filler and an ion conductive agent.

Conductivity is imparted to an electrophotographic belt by adding conductive particles to the surface layer for the purpose of imparting antistatic performance or the purpose of enhancing image quality in some cases. Japanese Patent Laid-Open No. 2007-316371 discloses an intermediate transfer belt including a surface layer containing a dispersant and conductive particles dispersed therein.

As a result of investigation by the inventor, the intermediate transfer belt disclosed in Japanese Patent Laid-Open No. 2007-316371 has soiled an electrophotographic photosensitive member (hereinafter referred to as “photosensitive member”) in contact with the intermediate transfer belt.

The present disclosure is directed to providing an electrophotographic belt of which at least one of bleed-out of a dispersant and an ion conductive agent is suppressed. The present disclosure is also directed to providing an electrophotographic apparatus capable of stably forming a high-quality image under high-temperature, high-humidity environments.

### SUMMARY OF THE DISCLOSURE

According to one embodiment of the present disclosure, there is provided an electrophotographic belt including a base layer and a surface layer. The surface layer contains a matrix containing a resin, a conductive particle dispersed in the matrix, and a dispersant. The matrix further contains a silicon oxide in a non-phase-separated state together with the resin. The silicon oxide is one derived from polysilazane.

According to another embodiment of the present disclosure, there is provided an electrophotographic belt including a base layer containing an ion conductive agent and a surface layer. The surface layer contains a matrix containing a resin. The matrix contains a silicon oxide in a non-phase-separated state together with the resin. The silicon oxide is one derived from polysilazane.

According to further embodiment of the present disclosure, there is provided an electrophotographic apparatus including an electrophotographic photosensitive member and a transfer device that transfers a toner image on the electrophotographic photosensitive member to a recording medium. The transfer device includes at least one of the electrophotographic belts.

Further features of the present disclosure will become apparent from the following description of exemplary embodiments with reference to the attached drawings.

### BRIEF DESCRIPTION OF THE DRAWINGS

FIG. 1 is a schematic sectional view of an electrophotographic belt according to an embodiment of the present disclosure.

FIG. 2 is a schematic view of a stretch blow molding apparatus according to an embodiment of the present disclosure.

FIG. 3 is a schematic sectional view of an electrophotographic apparatus according to an embodiment of the present disclosure.

### DESCRIPTION OF THE EMBODIMENTS

The intermediate transfer belt disclosed in Japanese Patent Laid-Open No. 2007-316371 has soiled the photosensitive member in contact with the intermediate transfer belt as described above. According to investigation by the inventor, the soiling is due to the fact that a dispersant contained in a surface layer bleeds out on a surface of the intermediate transfer belt.

According to further investigation by the inventor, when an electrophotographic belt includes a surface layer containing no dispersant and a base layer containing an ion conductive agent, the ion conductive agent bleeds out on a surface of the electrophotographic belt in some cases. In the case where the electrophotographic belt is left in a high-temperature, high-humidity environment for a long time, a dispersant and the ion conductive agent are particularly likely to bleed out. In the case where the dispersant or the ion conductive agent adheres to a surface of the electrophotographic belt, the surface of the electrophotographic belt may possibly be cracked by chemical attack.

Therefore, the inventor has investigated a method of suppressing the bleed-out of the dispersant and the ion conductive agent. As a result, the inventor has found that the bleed-out of the dispersant and the ion conductive agent can be suppressed by allowing resin in the surface layer to contain a silicon oxide in a non-phase-separated state.

The dispersant and the ion conductive agent are likely to migrate in a resin component in a matrix. However, in a resin layer containing the silicon oxide in resin in the non-phase-separated state, migration paths of the dispersant and the ion conductive agent in the resin layer are probably blocked on a microscopic level. Therefore, the inventor conceives that in the surface layer containing the silicon oxide in resin in the non-phase-separated state, the mobility of the dispersant and the ion conductive agent is low and the bleed-out of the dispersant and the ion conductive agent is suppressed.

In the present disclosure, the expression “a matrix which forms a surface layer and which contains resin contains a silicon oxide in a non-phase-separated state together with the resin” is particularly defined as described below.

Arbitrary five spots which are located in a surface layer in a through-thickness cross section of an electrophotographic belt and in which no conductive particles are present, that is, a silicon oxide is present in a matrix portion are observed, for example, at an accelerating voltage of 5 kV and 80,000× magnification using a scanning electron microscope (SEM). The case where the boundary between the resin and the silicon oxide cannot be identified in any of the five spots is defined as that the silicon oxide and the resin are in the non-phase-separated state.

The presence or absence of the silicon oxide in the matrix portion can be confirmed in such a manner that, for example, a through-thickness cross section of the electrophotographic belt is analyzed by energy dispersive X-ray spectroscopy (EDX) mapping at an accelerating voltage of 20 kV and 20,000× magnification using a scanning electron microscope (SEM), XL30 SFEG, available from FEI Ltd., equipped with an energy dispersive X-ray spectrometer (EDX), NEW XL30 132-2.5, available from EDAX Inc.

The surface layer can be obtained in such a manner that a paint containing polysilazane and a resin precursor is applied to a base layer and a coating film thereby formed is cured.

Embodiments of the present disclosure are described below in detail. The present disclosure is not limited to the embodiments.

### Electrophotographic Belt

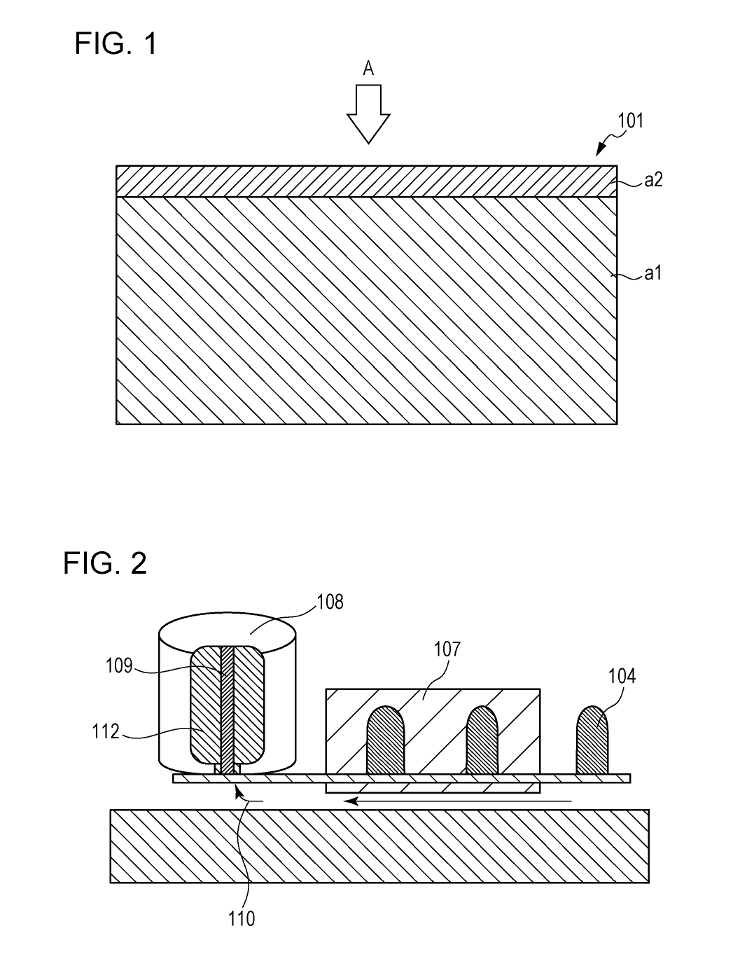

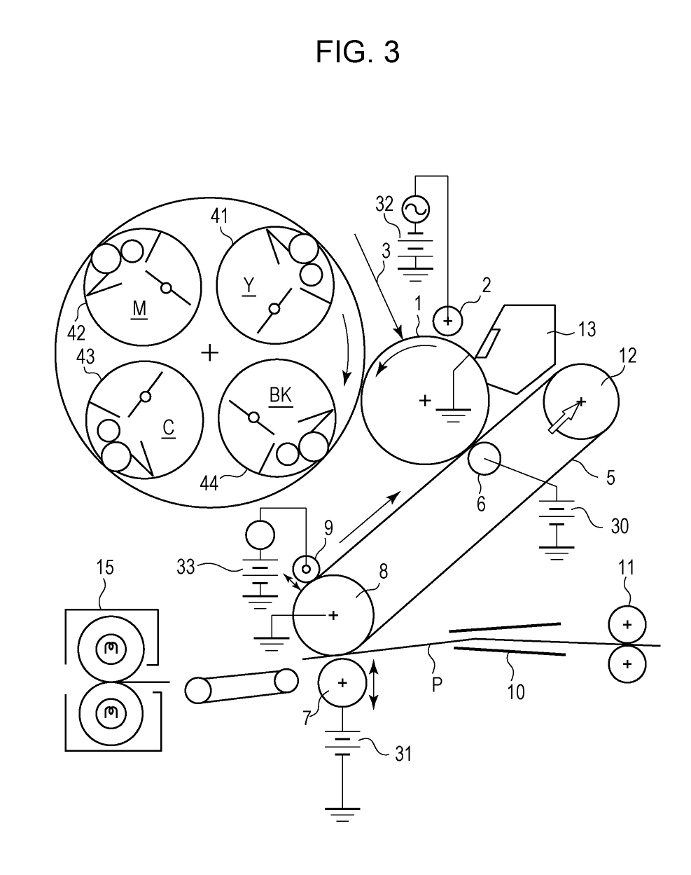

FIG. 1 is a lateral sectional view of an electrophotographic member having an endless belt shape, that is, an electrophotographic belt 101 according to an embodiment of the present disclosure. The electrophotographic belt 101 can be used as an electrophotographic belt 5 for use in an electrophotographic apparatus shown in FIG. 3. Referring to FIG. 1, Arrow A indicates an outer surface of the electrophotographic belt 101. The electrophotographic belt 101 includes a base layer a1 and a surface layer a2 placed on an outer peripheral surface of the base layer a1.

### Base Layer

A resin contained in the base layer a1 is not particularly limited. Various resins can be used for the base layer a1. Examples of the resin for the base layer a1 include resins such as polyimide (PI), polyamideimide (PAI), polypropylene (PP), polyethylene (PE), polyamide (PA), polylactic acid (PLA), polyethylene terephthalate (PET), polyethylene naphthalate (PEN), polyphenylene sulfide (PPS), polyether ether ketone (PEEK), polycarbonate (PC), and polyvinylidene fluoride (PVdF) and blends of the resins. Among the resins, polyethylene naphthalate (PEN) is particularly preferable for the base layer a1.

The base layer a1 may contain the following components in addition to the resin: for example, an ion conductive agent such as a polymeric ion conductive agent or a surfactant; a conductive polymer; an antioxidant such as a hindered phenol antioxidant, a phosphorus antioxidant, or a sulfur antioxidant; an ultraviolet absorber; an organic pigment; an inorganic pigment; a pH adjuster; a crosslinking agent; a compatibilizer; a release agent such as a silicone release agent or a fluoride silicone release agent; a coupling agent; a lubricant; an insulating filler such as zinc oxide, barium sulfate, calcium sulfate, barium titanate, potassium titanate, strontium titanate, titanium oxide, magnesium oxide, magnesium hydroxide, aluminium hydroxide, talc, mica, clay, kaolin, hydrotalcite, silica, alumina, ferrite, calcium carbonate, barium carbonate, nickel carbonate, a glass powder, a quartz powder, a glass fiber, an alumina fiber, a potassium titanate fiber, or fine particles of a thermosetting resin; a conductive filler such as carbon black, a carbon fiber, conductive titanium oxide, conductive tin oxide, or conductive mica; and an ionic liquid. The components contained in the base layer a1 may be used alone or in combination.

The base layer a1 preferably has a thickness of 10 μm to 500 μm and more preferably 30 μm to 150 μm.

A method of forming the base layer a1 is not particularly limited and may be one suitable for each resin. Examples of the method of forming the base layer a1 include extrusion molding, inflation molding, blow molding, and centrifugal molding.

### Surface Layer

The surface layer a2 contains a matrix containing resin. The matrix further contains a silicon oxide in the non-phase-separated state together with the resin. The silicon oxide is one derived from polysilazane. The surface layer a2 may further contain conductive particles and a dispersant.

Components of the surface layer a2 are described below.

### Matrix

The resin in the surface layer a2 is preferably an acrylic resin from the viewpoint of the abrasion resistance and hardness of the electrophotographic belt.

A polyfunctional (meth)acrylate is preferably used as a precursor of the acrylic resin from the viewpoint of the abrasion resistance of the electrophotographic belt. The term “(meth)acrylate” refers to an acrylate and a methacrylate.

Examples of a (meth)acrylate preferably used as the acrylic resin precursor include pentaerythritol tri(meth)acrylate, pentaerythritol tetra(meth)acrylate, trimethylolpropane tri(meth)acrylate, ethylene oxide-modified trimethylolpropane tri(meth)acrylate, polyphenylene oxide-modified trimethylolpropane tri(meth)acrylate, dipentaerythritol penta(meth)acrylate, dipentaerythritol hexa(meth)acrylate, ethylene oxide isocyanurate-modified di(meth)acrylate, ethylene oxide isocyanurate-modified tri(meth)acrylate, a pentaerythritol diacrylate-hexamethylene diisocyanate urethane prepolymer, a pentaerythritol diacrylate-toluene diisocyanate urethane prepolymer, a pentaerythritol diacrylate-isophorone diisocyanate urethane prepolymer, and a dipentaerythritol tetraacrylate-hexamethylene diisocyanate urethane prepolymer.

In particular, dipentaerythritol penta(meth)acrylate or dipentaerythritol hexa(meth)acrylate is preferably used as the acrylic resin precursor.

Several types of precursors may be used. In addition to the acrylic resin precursor, another resin precursor may be used for the purpose of adjusting the viscosity of a paint for forming the surface layer a2, for the purpose of reducing the contraction of a coating film, or for the purpose of adjusting the hardness of the surface layer a2 unless an effect of the present disclosure is impaired.

Polysilazane is a polymeric compound having the basic unit —SiH₂—NH— and is converted into the silicon oxide in a coating film in the presence of moisture in air or a hydroxy group in a solvent. The conversion reaction is represented by Reaction Formulae (1) and (2) below.

—(SiH₂—NH)—+2H₂O→—(SiO₂)—+NH₃+2H₂ (1)

—(SiH₂—NH)—+2O₂→—(SiO₂)—NH₃ (2)

In particular, polysilazane is preferably perhydropolysilazane represented by the formula —(SiH₂NH)ₙ—.

Polysilazane preferably has a number-average molecular weight of 50 to 10,000 and more preferably 1,000 to 3,000 from the viewpoints of the ease of drying polysilazane, the ease of dissolving polysilazane in a solvent, and the film formability of polysilazane.

In order to convert polysilazane into the silicon oxide, polysilazane is usually heated to 200° C. or higher. However, in the presence of an adequate catalyst, polysilazane can be converted into the silicon oxide at a temperature of lower than 200° C., particularly a room temperature of, for example, 23° C. In order to carry out the conversion of polysilazane into the silicon oxide at a temperature of 200° C. or lower, a metal complex or an amine curing catalyst is preferably used.

The content of polysilazane in the paint for forming the surface layer a2 is preferably 1% to 90% by mass and more preferably 10% to 90% by mass on the basis of resin and the solid matter of polysilazane. When the content of polysilazane is 1% by mass or more, the bleed of the dispersant and the ion conductive agent is sufficiently suppressed.

The fact that the silicon oxide is derived from polysilazane can be verified as described below.

Polysilazane reacts with water to produce the silicon oxide. However, a portion of polysilazane is not converted. Therefore, an Si—N bond remains in the surface layer a2, which contains the silicon oxide derived from polysilazane. The remaining Si—N bond disappears by, for example, calcining the silicon oxide derived from polysilazane at a high temperature of 900° C. for 1 hour. Thus, the fact that the silicon oxide in the surface layer a2 is derived from polysilazane can be confirmed through Steps (i) and (ii) below.

(i) A step of confirming the presence of the silicon oxide and Si—N bond in the surface layer a2.
(ii) A step of confirming that the Si—N bond is not present in residue obtained by calcining the surface layer a2 at high temperature.

The presence or absence of the silicon oxide in the surface layer a2 can be confirmed by energy dispersive X-ray spectroscopy (EDX) mapping analysis. The presence or absence of the Si—N bond in the surface layer a2 can be confirmed by Fourier transform infrared (FT-IR) spectroscopy. A particular verification method is described in an example.

The content of the acrylic resin in the matrix is preferably 10% to 99% by mass and more preferably 25% to 99% by mass on the basis of the matrix. When the content of the acrylic resin is 10% by mass or more, the surface layer a2 can be formed so as to have excellent abrasion resistance and therefore the durability of the electrophotographic belt is good.

### Conductive Particles

The conductive particles are dispersed in the matrix. The dispersant is preferably used to disperse the conductive particles in the matrix.

The conductive particles are not particularly limited and may be metal oxide particles, carbon particles, or conductive polymer particles. The term “conductive particles” refers to particles of a conductive substance which is not compatible with the matrix and which forms a conductive path in the matrix. The term “conductive particles” includes carbon nanotubes and carbon nanofibers which have a high aspect ratio.

Examples of the conductive particles include zinc antimonate particles, gallium-doped zinc oxide particles, antimony-doped tin oxide particles, indium-doped tin oxide particles, phosphorus-doped tin oxide particles, aluminium-doped zinc oxide particles, niobium-doped tin oxide particles, fluorine-doped tin oxide particles, gallium-doped tin oxide particles, particles of carbon black such as Ketjenblack and acetylene black, carbon nanotubes, carbon fibers, polypyrrole particles, and polythiophene particles. Several types of conductive particles may be used. In particular, the conductive particles are preferably the zinc antimonate particles from the viewpoint of exhibiting conductivity.

The content of the conductive particles in the surface layer a2 may be adjusted depending on desired electrical resistance and is preferably 1 part to 50 parts by mass per 100 parts by mass of the matrix. When the content of the conductive particles is 1 part by mass or more, sufficient electrical resistance can be obtained. When the content of the conductive particles is extremely large, the surface layer a2 may possibly be brittle. Therefore, the content of the conductive particles is preferably 50 parts by mass or less.

### Dispersant

The dispersant is not particularly limited and may be appropriately selected depending on the conductive particles and a solvent used. In particular, the dispersant is selected depending on the conductive particles so as to be adsorbed on the conductive particles. The dispersant is classified as a polymer-type dispersant or a surfactant-type dispersant depending on molecular morphology or is classified as an anionic dispersant, a cationic dispersant, or a nonionic dispersant depending on ion species.

Examples of the surfactant-type dispersant include anionic surfactants such as higher fatty acid salts, alkylsulfonates, alpha-olefinsulfonates, alkanesulfonates, alkylbenzenesulfonates, sulfosuccinic acid esters, alkylsulfonic acid esters, alkylethersulfonic acid esters, alkyletherphosphoric acid esters, alkylethercarboxylates, alpha-sulfo fatty acid methyl esters, and methyltaurates; nonionic surfactants such as glycerin fatty acid esters, polyglycerin fatty acid esters, sugar fatty acid esters, sorbitan fatty acid esters, polyoxyethylene sorbitan fatty acid esters, polyoxyethylene alkyl ethers, polyoxyethylene alkylphenyl ethers, polyoxyethylene fatty acid esters, fatty acid alkanol amides; and alkyl glucosides; cationic surfactants such as alkylamine salts and quaternary ammonium salts; and amphoteric surfactants such as alkyl betaines and alkyl amino fatty acid salts.

Examples of the polymer-type dispersant include block copolymers, random copolymers, and graft copolymers derived from at least two selected from the group consisting of styrene, styrene derivatives, vinylnaphthalene, vinylnaphthalene derivatives, aliphatic alcohol esters of α,β-ethylenically unsaturated carboxylic acids, acrylic acid, acrylic acid derivatives, methacrylic acid, methacrylic acid derivatives, maleic acid, maleic acid derivatives, alkenylsulfonic acids, vinylamine, allylamine, itaconic acid, itaconic acid derivatives, fumaric acid, fumaric acid derivatives, vinyl acetate, vinyl phosphonic acid, vinylpyrrolidone, acrylamide, N-vinylacetamide, N-vinylformamide, and N-vinylformamide derivatives, at least one of the two being a monomer containing at least one selected from the group consisting of a carboxy group, a sulfo group, a phospho group, a hydroxy group, and an alkylene oxide group, and also include modifications and salts of these copolymers. Other examples of the polymer-type dispersant include natural polymeric compounds such as albumin, cellulose, gelatin, rosin, shellac, starch, Arabic gum, and sodium alginate and modifications of the natural polymeric compounds.

Particular examples of the polymer-type dispersant include DISPERBYK™ 163, DISPERBYK™ 162, and DISPERBYK™ 180 available from Byk Chemie Japan K.K.

### Method of Forming Surface Layer

The surface layer a2 can be formed in such a manner that a paint containing the acrylic resin precursor, polysilazane, a solvent, and the conductive particles is applied to the base layer a1 and a coating film thereby formed is cured.

The type of the solvent is appropriately selected such that the solvent can stably dissolve the acrylic resin precursor and polysilazane. When the acrylic resin precursor used is a (meth)acrylate, toluene, xylene, or a ketone such as 2-butanone is preferably used. Since polysilazane reacts with water and a hydroxy group, the solvent, which dissolves polysilazane, is preferably one that contains few hydroxy groups and that has low water absorbability in consideration of the storage stability of the paint. In particular, the solvent used is preferably toluene, benzene, xylene, hexane, an ether such as dibutylether, or an ester. Thus, in the case where both the (meth)acrylate and polysilazane are dissolved, a solvent mixture of toluene, xylene, 2-butanone, and dibutylether is preferably used.

A method of preparing the paint is not particularly limited and is preferably one below.

The following slurry and solutions are prepared: slurry prepared by dispersing the conductive particles and the dispersant in the solvent, a solution prepared by dissolving the acrylic resin precursor in the solvent, and a solution prepared by dissolving polysilazane in the solvent. The slurry, the solutions, the solvent, and other components below are charged into a vessel equipped with a stirrer at a blending ratio below and are mixed together at room temperature for 30 minutes, whereby the paint is obtained. In the case where the conductive particles are dispersed from powder, a homogenizer or a bead mill is preferably used to disperse the conductive particles as required.

A method of forming the coating film from the paint may be, for example, a usual coating method such as dip coating, spray coating, flow coating, shower coating, roll coating, or spin coating.

When the acrylic resin precursor used is the (meth)acrylate, the coating film of the paint is cured by heat or radiation (light or an electron beam). In this case, the radiation is not particularly limited and may be active radiation that can impart energy capable of generating a polymerization-initiating species. The radiation includes α-rays, γ-rays, X-ray, ultraviolet (UV) rays, visible rays, and electron beams. Among these rays and beams, an ultraviolet ray and an electron beam are preferable from the viewpoint of curing sensitivity and the availability of an apparatus. In particular, the ultraviolet ray is preferable.

The paint for forming the surface layer a2, may further contain other components such as a radical polymerization initiator, as required. Details of the components are described hereinafter.

### Radical Polymerization Initiator

The radical polymerization initiator may be, for example, a compound (thermal polymerization initiator) thermally generating active radial species or a compound (radiation (light) polymerization initiator) generating active radial species by radiation (light) irradiation.

The radiation (light) polymerization initiator is not particularly limited and may be one that is decomposed into radicals by light irradiation to initiate polymerization. Examples of the radiation (light) polymerization initiator include acetophenone, acetophenone benzylketal, 1-hydroxycyclohexylphenylketone, 2,2-dimethoxy-1,2-diphenylethane-1-one, xanthone, fluorenone, benzaldehyde, fluoren, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholinopropane-1-one, 2-benzyl-2-dimethylamino-1-(4-morpholinophenyl)-butanone-1, 4-(2-hydroxyethoxy)phenyl-(2-hydroxy-2-propyl) ketone, 2,4,6-trimethylbenzoyldiphenylphosphine oxide, bis-(2,6-dimethoxybenzoyl)-2,4,4-trimethylpentylphosphine oxide, and oligo(2-hydroxy-2-methyl-1-[4-(1-methylvinyl)phenyl]propanone.

The amount of the blended radical polymerization initiator is preferably 0.01 parts by mass to 10 parts by mass and more preferably 0.1 parts by mass to 5 parts by mass per 100 parts by mass of the acrylic resin precursor. When the amount of the radical polymerization initiator is controlled within the range, the surface layer a2 has sufficient hardness.

### Another Component

The paint may contain another component as required unless an effect of the present disclosure is not impaired. Examples of the component include polymerization inhibitors, polymerization initiation aids, leveling agents, wettability improvers, surfactants, plasticizers, ultraviolet absorbers, antioxidants, antistatic agents, inorganic fillers, and pigments.

### Electrophotographic Apparatus

An electrophotographic apparatus according to an embodiment of the present disclosure includes an electrophotographic photosensitive member and a transfer device for transferring a toner image formed on the electrophotographic photosensitive member to a recording medium. The transfer device includes an intermediate transfer belt that is the electrophotographic belt 5 according to the above embodiment.

In particular, the electrophotographic apparatus includes the electrophotographic photosensitive member, a primary transfer device for primarily transferring an unfixed toner image formed on the electrophotographic photosensitive member to the intermediate transfer belt, and a secondary transfer device for secondarily transferring the toner image, transferred to the intermediate transfer belt, to the recording medium. The intermediate transfer belt is the electrophotographic belt 5 according to the above embodiment.

FIG. 3 is a schematic sectional view of the electrophotographic apparatus, which is a full-color type. In FIG. 3, the electrophotographic belt 5 according to the above embodiment is used as an intermediate transfer belt.

A rotary drum type of electrophotographic photosensitive member 1 repeatedly used as a first image-carrying member is rotationally driven at a predetermined peripheral speed (process speed) in the direction of an arrow.

The electrophotographic photosensitive member 1 is uniformly charged to a predetermined polarity and potential with a primary charger 2 during rotation. The electrophotographic photosensitive member 1 receives an image exposure 3 from an exposure device, whereby an electrostatic latent image corresponding to a first color component image (for example, a yellow component image) of a target color image is formed on the electrophotographic photosensitive member 1.

Example of the exposure device include a color separation/imaging exposure optical system for color original images and a scanning exposure system including a laser scanner outputting a laser beam modulated depending on a time-series electric digital pixel signal of image information. The electrostatic latent image on the electrophotographic photosensitive member 1 is developed with a first developing unit (a yellow developing unit 41) using a yellow toner Y corresponding to a first color, whereby a yellow toner image with the first color is formed. In this operation, second to fourth developing units (a magenta developing unit 42, a cyan developing unit 43, and a black developing unit 44) are off and therefore do not act on the electrophotographic photosensitive member 1; hence, the yellow toner image, which has the first color, is not affected by the second to fourth developing units.

The electrophotographic belt 5 is rotationally driven at the same peripheral speed as that of the electrophotographic photosensitive member 1 in the direction of an arrow. The yellow toner image on the electrophotographic photosensitive member 1 is transferred to the outer peripheral surface of the electrophotographic belt 5 by an electric field generated by the primary transfer bias applied to the electrophotographic belt 5 from a power supply 30 through a primary transfer facing roller 6 when the yellow toner image passes through a nip between the electrophotographic photosensitive member 1 and the electrophotographic belt 5 (primary transfer). A surface of the electrophotographic photosensitive member 1 is cleaned with a cleaning device 13 after the yellow toner image, which has the first color, is transferred to the electrophotographic belt 5.

Likewise, a magenta toner image with a second color, a cyan toner image with a third color, and a black toner image with a fourth color are sequentially transferred to the electrophotographic belt 5 so as to be superimposed on the electrophotographic belt 5, whereby a synthetic color toner image corresponding to the target color image is formed. A secondary transfer roller 7 is born in parallel to a driving roller 8 and is movably placed under the electrophotographic belt 5. The secondary transfer roller 7 can be moved away from the electrophotographic belt 5 in a step of primarily transferring the yellow, magenta, and cyan toner images from the electrophotographic photosensitive member 1 to the electrophotographic belt 5.

The synthetic color toner image transferred to the electrophotographic belt 5 is transferred to a recording medium P that is a second image-carrying member as described below. The secondary transfer roller 7 is brought into contact with the electrophotographic belt 5 and the recording medium P is fed to a contact nip between the electrophotographic belt 5 and the secondary transfer roller 7 from a sheet-feeding roller 11 through a recording medium guide 10 with appropriate timing. A secondary transfer bias is applied to the secondary transfer roller 7 from a power supply 31. The synthetic color toner image is transferred (secondarily transferred) to the recording medium P, which is the second image-carrying member, from the electrophotographic belt 5 by the secondary transfer bias. The recording medium P having the transferred synthetic color toner image is introduced into a fixing device 15 and is then heat-fixed. After the transfer of the synthetic color toner image to the recording medium P is completed, an electrophotographic belt-cleaning roller 9 of a cleaning device is brought into contact with the electrophotographic belt 5 and a bias opposite in polarity to the electrophotographic photosensitive member 1 is applied to the electrophotographic belt 5. This applies a charge opposite in polarity to the electrophotographic photosensitive member 1 to toner (untransferred toner) which remains on the electrophotographic belt 5 without being transferred to the recording medium P. Untransferred toner is electrostatically transferred to the electrophotographic photosensitive member 1 at the nip between the electrophotographic photosensitive member 1 and the electrophotographic belt 5 and near the nip therebetween, whereby the electrophotographic belt 5 is cleaned.

An electrophotographic apparatus according to an embodiment of the present disclosure is not limited to one described above. An electrophotographic apparatus according to another embodiment of the present disclosure includes an electrophotographic photosensitive member and a transfer device for transferring a toner image formed on the electrophotographic photosensitive member to a recording medium P conveyed on a conveying transfer belt, the conveying transfer belt being an embodiment of the present disclosure.

An embodiment of the present disclosure provides a transfer belt which is unlikely to soil a photosensitive member because the bleed-out of a dispersant and an ion conductive agent is suppressed even in the case where the transfer belt is left in a high-temperature, high-humidity environment for a long time.

Another embodiment of the present disclosure provides an electrophotographic apparatus capable of forming a high-quality image stable in high-temperature, high-humidity environments.

### EXAMPLES

The present disclosure is further described below in detail with reference to examples and comparative examples. The scope of the present disclosure is not limited to the examples.

### Preparation of Base Layer

### Base Layer No. 1 (Electronically Conductive Base Layer)

Resin materials shown in Table 1 were melt-kneaded using a twin-screw extruder, TEX 30α, available from The Japan Steel Works, Ltd., whereby a thermoplastic resin composition was prepared. The melt-kneading temperature was adjusted within the range of 350° C. to 380° C. The obtained thermoplastic resin composition was pelletized.

The pelletized thermoplastic resin composition was charged into a single-screw extruder, GT40, available from Research Laboratory of Plastics Technology Co., Ltd., the single-screw extruder being preset to a temperature of 380° C., and was melt-extruded through an annular die, whereby an extrudate having a tubular shape, was obtained. Then, the extrudate was cut into a base layer, which has an endless-belt shape, for use in an electrophotographic belt. The base layer is hereinafter referred to as Base Layer No. 1. The base layer No. 1 had a thickness of 70 μm and a surface resistivity of 5.0×10¹¹ Ω/square.

TABLE 1

| | Amount |
|---|---|
| Resin materials | (parts by mass) |
| PEEK: polyether ether ketone, VICTREX PEEK 381G, | 100 |
| available from Victrex PLC | |
| Carbon: acetylene black, DENKA BLACK, available | 20 |
| from Denka Co., Ltd. | |

### Base Layer No. 2 (Ionically Conductive Base Layer)

Resin materials shown in Table 2 were melt-kneaded using a twin-screw extruder, TEX 30α, available from The Japan Steel Works, Ltd., whereby a thermoplastic resin composition was prepared. The melt-kneading temperature was adjusted within the range of 260° C. to 280° C. The melt-kneading time was adjusted to about 3 minutes to 5 minutes. The obtained thermoplastic resin composition was pelletized and was then dried at 140° C. for 6 hours. The dry pelletized thermoplastic resin composition was charged into an injection molding machine, SE 180D, available from Sumitomo Heavy Industries, Ltd. The resulting thermoplastic resin composition was injected into a die controlled at a temperature of 30° C. at a cylinder preset temperature of 295° C., whereby a preform 104 was prepared. The obtained preform 104 had a test tube shape, an outside diameter of 20 mm, an inside diameter of 18 mm, and a length of 150 mm.

TABLE 2

| | Amount |
|---|---|
| | (parts by |
| Resin materials | mass) |
| PEN: polyethylene naphthalate, TR-8550, available from | 100 |
| Teijin Chemicals Ltd. | |
| PEEA: polyether ester amide, PELESTAT NC6321, available | 20 |
| from Sanyo Chemical Industries, Ltd. | |
| Lithium perchlorate available from Japan Carlit Co., Ltd. | 2 |
| Carbon, MA-100, available from Mitsubishi Chemical | 1 |
| Corporation | |

The preform 104 was biaxially stretched using a biaxial stretching machine (stretch blow molding machine) shown in FIG. 2. Before being biaxially stretched, the preform 104 was put in a heating device 107 equipped with a noncontact heater (not shown) for the purpose of heating outer and inner walls of the preform 104 and was heated with the noncontact heater such that the surface temperature of the preform 104 reached 120° C. The heated preform 104 was put in a blow die 108 maintained at 30° C. and was then axially stretched using a stretching rod 109. At the same time, the preform 104 was radially stretched in such a manner that air controlled at a temperature of 23° C. was introduced into the preform 104 from a blow air injection port 110, whereby a bottle-shaped molding 112 was obtained.

A middle portion of the obtained bottle-shaped molding 112 was cut, whereby a base layer for use in an electrophotographic belt was obtained. The base layer had a thickness of 70 μm and a surface resistivity of 3×10¹⁰ Ω/square. The base layer is hereinafter referred to as Base Layer No. 2.

### Preparation of Paints

### Acrylic Solution

An acrylic solution with an acrylic monomer concentration of 20% by weight was obtained in such a manner that 95 parts by weight of a mixture (KAYARAD DPHA, available from Nippon Kayaku Co., Ltd.) of dipentaerythritol pentaacrylate and dipentaerythritol hexaacrylate serving as an acrylic monomer, 5 parts by weight of 2-methyl-1-(4-methylthiophenyl)-2-morpholinopropane-1-one (a polymerization initiator, Irgacure 907, available from BASF Japan Ltd.), and 400 parts by weight of 2-butanone (2-Butanone, available from Kishida Chemical Co., Ltd.) were introduced into a lidded vessel made of polypropylene and were mixed for 30 minutes using a mixing rotor.

### Polysilazane Solution

The following solution was used: a perhydropolysilazane solution, AZ NAX 120-20, available from AZ Electronic materials PLC (now Merck Ltd., Japan), the perhydropolysilazane solution having a number-average molecular weight of 1,200 to 2,500 and containing dibutyl ether, 20% by weight of perhydropolysilazane, and 5% by weight of an amine catalyst.

### Paint Nos. 1 to 6, 8, 9, and 12 to 14

Materials were weighed at a blending ratio shown in Table 1, were charged into a lidded vessel made of polypropylene, and were mixed for 30 minutes using a mixing rotor, whereby each paint was obtained.

Conductive Particles No. 1 were formed using a carbon slurry, MHI Black #220, available from Mikuni Color Ltd., the carbon slurry having a solid content of 40% and containing a polyester-based polymeric dispersant.

Conductive Particles No. 2 were formed using a polypyrrole slurry, CDP-310M, available from Japan Carlit Co., Ltd., the polypyrrole slurry having a solid content of 10% and containing a dispersant.

### Paint Nos. 7, 10, and 11

Materials were weighed at a blending ratio shown in Table 1, were charged into a lidded vessel made of polypropylene, were mixed for 30 minutes using a mixing rotor, and were treated in a homogenizer for 15 minute, whereby each paint was obtained.

Conductive Particles No. 3 used were tin oxide-based conductive particles, SN 100P, available from Ishihara Sangyo Kaisha, Ltd., the tin oxide-based conductive particles having a solid content of 100% and containing no dispersant. A dispersant used was an amino group-containing polymeric dispersant, DISPERBYK-168, available from Byk Chemie Japan K.K. Silica particles used were hydrophobic fumed silica, AEROSIL R972, available from Nippon Aerosil Co., Ltd., the hydrophobic fumed silica having a solid content of 100%.

TABLE 3

| | Blending ratio (parts by mass) | | | | | | |
|---|---|---|---|---|---|---|---|
| | | | | Conductive | Conductive | Conductive | |
| | Acrylic solution | Polysilazane | | Particles No. 1 | Particles No. 2 | Particles No. 3 | |
| | (containing | solution | | (containing | (containing | (containing no | |
| Paint | polymerization | (containing | Silica | solvent and | solvent and | solvent or | |
| No. | initiator and solvent) | solvent) | particles | dispersant) | dispersant) | dispersant) | Dispersant |
| 1 | 25 | 75 | — | 15 | — | — | — |
| 2 | 50 | 50 | — | 15 | — | — | — |
| 3 | 75 | 25 | — | 15 | — | — | — |
| 4 | 95 | 5 | — | 15 | — | — | — |
| 5 | 99 | 1 | — | 15 | — | — | — |
| 6 | 95 | 5 | — | — | 60 | — | — |
| 7 | 95 | 5 | — | — | — | 6 | 1 |
| 8 | 100 | — | — | 15 | — | — | — |
| 9 | 100 | — | — | — | 60 | — | — |
| 10 | 100 | — | — | — | — | 6 | 1 |
| 11 | 95 | — | 5 | 15 | — | — | — |
| 12 | 100 | — | — | — | — | — | — |
| 13 | — | 100 | — | 15 | — | — | — |
| 14 | 50 | 50 | — | — | — | — | — |

### Formation of Surface Layers

In each of examples and comparative examples below, a surface layer was formed by dip coating.

The base layer obtained by blow molding as described above was fitted to the outer periphery of a cylindrical die, followed by sealing an end portion of the base layer. The base layer was immersed in a vessel filled with paint together with the cylindrical die and was pulled up such that the rate of the base layer relative to the level of the paint was constant, whereby a coating film of the paint was formed on a surface of the base layer. In dip coating, the pulling rate (the rate of the base layer relative to the level of the paint) and the proportion of a solvent in the paint is adjusted depending on a desired thickness. In each of the examples, the comparative examples, and reference examples below, the pulling rate was adjusted between 10 mm/s to 50 mm/s such that the thickness of the surface layer was 3 μm.

After the coating film was formed, the coating film was dried at 23° C. for 1 minute. The drying temperature and drying time of the coating film may be appropriately adjusted depending on the type of the solvent in the paint, the proportion of the solvent in the paint, or the thickness of the surface layer.

The dry coating film was irradiated with an ultraviolet ray using a UV irradiator, UE 06/81-3, available from EYE GRAPHICS Co., Ltd. until the integral light quantity reached 600 mJ/cm² such that the coating film was cured, whereby the surface layer was formed. A cross section of the surface layer was observed with an electron microscope. As a result, the thickness of the surface layer was 3 μm.

### Evaluation Method

An electrophotographic belt according to each of the examples, the comparative examples, and the reference examples was evaluated as described below. Evaluation results of the electrophotographic belt are summarized in Table 2.

### Bleed-Out Evaluation (1)

The presence or absence of bleed-out was evaluated as described below. Each electrophotographic belt was left in an environment with a temperature of 40° C. and a relative humidity of 95% for 1 week in such a state that the surface layer of the electrophotographic belt was in contact with a photosensitive member of a laser beam printer, LBP-5200, available from CANON KABUSHIKI KAISHA. Thereafter, a surface of the photosensitive member that was in contact with the electrophotographic belt was observed with an optical microscope at 100× magnification, whereby the presence or absence of deposits on the photosensitive member surface and the presence or absence of cracks in the photosensitive member surface. The electrophotographic belt was evaluated on the basis of standards below.

A: None of deposits and cracks is present.
B: Either a deposit or a crack is present.

### Bleed-Out Evaluation (2)

An electrophotographic belt according to each of Examples 1 to 3 and 6 to 9 was kept in contact with an electrophotographic photosensitive member for 4 weeks and was then subjected to Bleed-out Evaluation (2). An evaluation method and evaluation standards were the same as those for Bleed-out Evaluation (1).

### Evaluation of Durability

The surface layer of each electrophotographic belt was evaluated for durability as described below. The electrophotographic belt was fitted to an intermediate transfer unit of a laser beam printer, LBP-5200, available from CANON KABUSHIKI KAISHA so as to serve as an intermediate transfer belt. An image was printed on 100,000 A4-size sheets, Canon Extra Multifunctional Paper 80 g/m², available from CANON KABUSHIKI KAISHA in an environment with a temperature of 15° C. and a relative humidity of 10% using the laser beam printer. Thereafter, a surface of the electrophotographic belt was visually observed, thereby confirming the presence or absence of cracks and peeled portions in the surface layer. The electrophotographic belt was evaluated on the basis of standards below.

A: None of cracks and peeled portions is present in the surface layer.
B: Either or both of a crack and a peeled portion are present in the surface layer.
Verification of Silicon Oxide Derived from Polysilazane

A through-thickness cross section of each electrophotographic belt was exposed with a cross-section polisher, SM-09010, available from JEOL Ltd. at an acceleration voltage of 4 kV and a current of 70 μA over 10 hours using an argon gas. After carbon was vapor-deposited on the through-thickness cross section, the through-thickness cross section was analyzed by energy dispersive X-ray spectroscopy (EDX) mapping. EDX mapping analysis was performed at an accelerating voltage of 20 kV and 20,000× magnification using a scanning electron microscope (SEM), XL 30 SFEG, available from FEI Ltd., equipped with an energy dispersive X-ray spectrometer (EDX), NEW XL30 132-2.5, available from EDAX Inc. Arbitrary five spots in the through-thickness cross section were analyzed. The case where the presence of Si could be confirmed in all of the five analyzed spots was regarded as the presence of a silicon oxide in a matrix. The case where the presence of Si could not be confirmed in any of the five analyzed spots was regarded as the absence of the silicon oxide in the matrix.

Furthermore, an FT-IR spectrum of a surface of the electrophotographic belt was measure by an attenuated total reflection (ATR) method. In an IR spectrum, peaks corresponding to an Si—O bond appear at about 1,070 cm⁻¹ and 800 cm⁻¹ and a peak corresponding to an Si—N bond appears at about 950 cm⁻¹.

This enables the presence or absence of the Si—O bond and the Si—N bond to be confirmed. Thereafter, a portion of the surface layer was scraped and was then calcined at 900° C. for 1 hour, whereby residue was obtained. The residue was subjected to FT-IR measurement by a KBr method, whereby the presence or absence of a peak at about 950 cm⁻¹ was confirmed. After a 100-fold weight of KBr was added to the residue and KBr and the residue were ground in an agate mortar, were mixed together, and were then formed into a tablet, IR measurement was performed. IR measurement was performed using an IR measuring apparatus, Frontier FT MIR/NIR, available from PerkinElmer Japan Co., Ltd. with a resolution of 0.5 cm⁻¹ and a number of scans of 30.

### Confirmation of Non-Phase-Separated State

In a matrix of a surface layer, the presence or absence of the boundary between resin and a silicon oxide was observed in such a manner that regions (five spots) where the presence of Si could be confirmed by EDX as described above were observed at an accelerating voltage of 5 kV and 80,000× magnification using the above SEM.

### Examples 1 to 7

An electrophotographic belt according to each of Examples 1 to 7 was prepared in such a manner that a surface layer was formed by dipping Base Layer No. 1 in a corresponding one of Paint Nos. 1 to 7. In the electrophotographic belt, it was confirmed that a silicon oxide derived from polysilazane was contained in the surface layer in a non-phase-separated state. In the electrophotographic belt, no cracks or deposits were confirmed on a surface of a photosensitive member and the durability of the surface layer was good.

### Examples 8 and 9

An electrophotographic belt according to each of Examples 8 and 9 was prepared in such a manner that a surface layer was formed by dipping Base Layer No. 2 in a corresponding one of Paint Nos. 2 and 14. In the electrophotographic belt, it was confirmed that a silicon oxide derived from polysilazane was contained in the surface layer in a non-phase-separated state. In the electrophotographic belt, no cracks or deposits were confirmed on a surface of a photosensitive member and the durability of the surface layer was good.

### Comparative Examples 1 to 3

An electrophotographic belt according to each of Comparative Examples 1 to 3 was prepared in such a manner that a surface layer was formed by dipping Base Layer No. 1 in a corresponding one of Paint Nos. 8 to 10. Paint Nos. 8 to 10 contained no polysilazane. In the electrophotographic belt, bleed-out was not suppressed and cracks and deposits were confirmed on a surface of a photosensitive member.

### Comparative Example 4

An electrophotographic belt according to Comparative Example 4 was prepared in such a manner that a surface layer was formed by dipping Base Layer No. 1 in Paint No. 11. Paint No. 11 contained no polysilazane. In the electrophotographic belt according to Comparative Example 4, bleed-out was not suppressed and cracks and deposits were confirmed on a surface of a photosensitive member.

### Comparative Example 5

An electrophotographic belt according to Comparative Example 5 was prepared in such a manner that a surface layer was formed by dipping Base Layer No. 2 in Paint No. 12. Paint No. 12 contained no polysilazane. In the electrophotographic belt according to Comparative Example 5, bleed-out was not suppressed and cracks and deposits were confirmed on a surface of a photosensitive member.

### Comparative Example 6

An electrophotographic belt according to Comparative Example 6 was prepared in such a manner that a surface layer was formed by dipping Base Layer No. 1 in Paint No. 13. Paint No. 13 did not contain an acrylic resin but contained polysilazane. In the electrophotographic belt according to Comparative Example 6, bleed-out was suppressed and the durability of the surface layer was, however, insufficient.

### Reference Example 1

An electrophotographic belt according to Reference Example 1 was prepared in such a manner that a surface layer was formed by dipping Base Layer No. 2 in Paint No. 12. Paint No. 12 contained no polysilazane or conductive particles. In the electrophotographic belt according to Reference Example 1, no cracks or deposits were confirmed on a surface of a photosensitive member. This is probably because Paint No. 12 contained no dispersant.

### Reference Example 2

An electrophotographic belt according to Reference Example 2 was Base Layer No. 2 provided with no surface layer. In the electrophotographic belt according to Reference Example 2, cracks and deposits were confirmed on a surface of a photosensitive member. This is probably because an ion conductive agent contained in Base Layer No. 2 bled out.

For the electrophotographic belts according to Examples 1 to 9, Comparative Examples 1 to 6, and Reference Examples 1 and 2, the type of a base layer, the type of paint used to form a surface layer, results of Bleed-out Evaluation (1), results of durability evaluation, and analysis results are shown in Table 4.

TABLE 4

| | | | | | Analysis results | | | | |
|---|---|---|---|---|---|---|---|---|---|
| | | | | | | | | | Phase-sep- |
| | | | Bleed- | | | | | | arated state |
| | | | out | Dura- | Cross- | | | IR after | Boundary |
| | | | Evalu- | bility | sectional | IR before calcination | | calcination | between |
| | Base | | ation | evalu- | EDX | Si—O | Si—N | Si—N | resin and |
| | Layer | Paint | (1) | ation | Si | bond | bond | bond | silicon oxide |
| Example 1 | No. 1 | No. 1 | A | A | Observed | Observed | Observed | Not | Not |
| | | | | | | | | observed | observed |
| Example 2 | No. 1 | No. 2 | A | A | Observed | Observed | Observed | Not | Not |
| | | | | | | | | observed | observed |
| Example 3 | No. 1 | No. 3 | A | A | Observed | Observed | Observed | Not | Not |
| | | | | | | | | observed | observed |
| Example 4 | No. 1 | No. 4 | A | A | Observed | Observed | Observed | Not | Not |
| | | | | | | | | observed | observed |
| Example 5 | No. 1 | No. 5 | A | A | Observed | Observed | Observed | Not | Not |
| | | | | | | | | observed | observed |
| Example 6 | No. 1 | No. 6 | A | A | Observed | Observed | Observed | Not | Not |
| | | | | | | | | observed | observed |
| Example 7 | No. 1 | No. 7 | A | A | Observed | Observed | Observed | Not | Not |
| | | | | | | | | observed | observed |
| Comparative | No. 1 | No. 8 | B | A | Not | Not | Not | Unanalyzed | Not |
| Example 1 | | | | | observed | observed | observed | | observed |
| Comparative | No. 1 | No. 9 | B | A | Not | Not | Not | Unanalyzed | Not |
| Example 2 | | | | | observed | observed | observed | | observed |
| Comparative | No. 1 | No. 10 | B | A | Not | Not | Not | Unanalyzed | Not |
| Example 3 | | | | | observed | observed | observed | | observed |
| Comparative | No. 1 | No. 11 | B | A | Not | Observed | Not | Unanalyzed | Observed |
| Example 4 | | | | | observed | | observed | | |
| Example 8 | No. 2 | No. 2 | A | A | Observed | Observed | Observed | Not | Not |
| | | | | | | | | observed | observed |
| Example 9 | No. 2 | No. 14 | A | A | Observed | Observed | Observed | Not | Not |
| | | | | | | | | observed | observed |
| Comparative | No. 2 | No. 12 | B | A | Not | Not | Not | Unanalyzed | Not |
| Example 5 | | | | | observed | observed | observed | | observed |
| Comparative | No. 1 | No. 13 | A | B | Observed | Observed | Observed | Not | Not |
| Example 6 | | | | | | | | observed | observed |
| Reference | No. 1 | No. 12 | A | A | Not | Not | Not | Unanalyzed | Not |
| Example 1 | | | | | observed | observed | observed | | observed |
| Reference | No. 2 | Not | B | Unevaluated | Unanalyzed | Unanalyzed | Unanalyzed | Unanalyzed | Unanalyzed |
| Example 2 | | used | | | | | | | |

For the electrophotographic belts according to Examples 1 to 3 and 6 to 9, results of Bleed-out Evaluation (2) are shown in Table 5.

TABLE 5

| Fixing belt | Bleed-out Evaluation (2) |
|---|---|
| Example 1 | A |
| Example 2 | A |
| Example 3 | A |
| Example 6 | A |
| Example 7 | A |
| Example 8 | A |
| Example 9 | A |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2015-107876, filed May 27, 2015, which is hereby incorporated by reference herein in its entirety.

What is claimed is:

1. An electrophotographic belt comprising:
a base layer; and
a surface layer,
wherein the surface layer contains a matrix containing a resin, a conductive particle dispersed in the matrix, and a dispersant; the matrix further contains a silicon oxide in a non-phase-separated state together with the resin; and the silicon oxide is derived from polysilazane.

2. The electrophotographic belt according to claim 1, wherein the resin is an acrylic resin.

3. The electrophotographic belt according to claim 2, wherein the content of the acrylic resin in the matrix is 10% to 99% by mass.

4. The electrophotographic belt according to claim 2, wherein the acrylic resin is obtained by curing a polyfunctional (meth)acrylate.

5. The electrophotographic belt according to claim 1, wherein the base layer is made of polyethylene naphthalate (PEN).

6. The electrophotographic belt according to claim 1, wherein the surface layer is formed by curing a coating film of a paint containing the polysilazane and a precursor of the resin.

7. An electrophotographic belt comprising:
a base layer containing an ion conductive agent; and
a surface layer,
wherein the surface layer contains a matrix containing resin, the matrix contains a silicon oxide in a non-phase-separated state together with the resin, and the silicon oxide is derived from polysilazane.

8. The electrophotographic belt according to claim 7, wherein the resin is an acrylic resin.

9. The electrophotographic belt according to claim 8, wherein the content of the acrylic resin in the matrix is 10% to 99% by mass.

10. The electrophotographic belt according to claim 7, wherein the surface layer is formed by curing a coating film of a paint containing the polysilazane and a precursor of the resin.

11. The electrophotographic belt according to claim 10, wherein the resin precursor is a polyfunctional (meth)acrylate.

12. An electrophotographic apparatus comprising:
an electrophotographic photosensitive member; and
a transfer device that transfers a toner image formed on the electrophotographic photosensitive member to a recording medium,
wherein the transfer device includes the electrophotographic belt according to claim 1.

13. An electrophotographic apparatus comprising:
an electrophotographic photosensitive member; and
a transfer device that transfers a toner image formed on the electrophotographic photosensitive member to a recording medium,
wherein the transfer device includes the electrophotographic belt according to claim 7.
